(19) United States
(12) Patent Application Publication
(10) Pub. No.: US 2005/0162318 A1
(43) Pub. Date: Jul. 28, 2005

(54) Miniaturized patch antenna

(75) Inventor: Masahiko Higasa, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/033,520

(22) Filed: Jan. 11, 2005

(30) Foreign Application Priority Data
Jan. 13, 2004 (JP) 2004-005722

(51) Int. Cl. H01Q 1/48

(52) U.S. Cl. 343/700 MS; 343/846

(57) ABSTRACT

A patch antenna contains a dielectric substrate, a radiating electrode formed almost entirely on a top surface of the dielectric substrate, a grounding electrode having four notched portions and provided on a bottom surface of the dielectric substrate, and a feeding pin passing through the dielectric substrate and being connected to a feeding point of the radiating electrode. Degeneracy breaking elements are disposed on the radiating electrode. The notched portions are formed at positions close to approximately middle portions of four sides of the dielectric substrate, and the grounding electrode is formed almost entirely on the bottom surface of the dielectric substrate, except for areas corresponding to the respective notched portions. The grounding electrode is not formed larger than the radiating electrode.

### BACKGROUND OF THE INVENTION

1. Field of the Invention

The present invention relates to a patch antenna in which a radiating electrode and a grounding electrode are provided on a top surface and a bottom surface of a dielectric substrate, respectively.

2. Description of the Related Art

Currently, the demand for patch antennas as a dielectric antenna having miniaturized and thinner structure is increasing. The patch antenna generally comprises a dielectric substrate, a radiating electrode (a patch electrode) which has a predetermined shape and which is provided on a top surface of the dielectric substrate, a grounding electrode (a rear electrode) which is provided on a bottom surface of the dielectric substrate, and a feeding means, such as a feeding pin, which feeds power to the radiating electrode. Here, the dielectric substrate contributes to the miniaturization of the radiating electrode through the wavelength shortening effect.

Such a patch antenna can be used as a circularly polarized wave antenna or a linear polarized wave antenna, and its radiation pattern can be adjusted such that an optimum directional characteristic may be obtained according to the usage. For example, in the case where a patch antenna operates as the circularly polarized antenna for the GPS (Global Positioning System), if a gain in the zenith direction is small, circularly polarized waves can not be surely received from the GPS satellite. Accordingly, in this case, the radiation pattern is needed to be adjusted so as to obtain a sufficient gain in the zenith direction. In a conventional patch antenna which is designed so as to obtain a high gain in the zenith direction, there are many cases in which a grounding electrode is generally formed larger than a radiating electrode and is provided on a substantially entire bottom surface of the dielectric substrate (for example, see Japanese Unexamined Patent Application Publication No. 6-152237 (page 2 and FIG. 5)).

### SUMMARY OF THE INVENTION

As described above, in order to increase the gain in the zenith direction of the patch antenna, a method in which the grounding electrode is formed larger than the radiating electrode is widely used. If doing so, the path lengths and directions of induced current in the grounding electrode are varied. Accordingly, the downward radiation caused by the induced current weakens and the radiation in the zenith direction strengthens at the same rate opposite to the weakening rate. However, since a large dielectric substrate is required so as to form a large grounding electrode, there is a problem in that a patch antenna increases in size.

The present invention has been in consideration of the problems inherent in the conventional art, and it is an object of the present invention to provide a patch antenna which can increase a gain in the zenith direction without sacrificing miniaturization.

In order to achieve the above-mentioned object, according to the present invention, there is provided a patch antenna comprising a radiating electrode which is provided on a top surface of a dielectric substrate, and a grounding electrode which has a concave notched portion and which is provided on a bottom surface of the dielectric substrate.

When the notched portion is formed at an outer circumferential edge of the grounding electrode (rear electrode), the path length of an induced current component flowing to the outer circumferential edge can be lengthened without interfering with the flow of a main inducted current component crossing a central portion of the grounding electrode, among induced current in the grounding electrode, crossing a center thereof. Thus, the downward radiation due to the induced current of the grounding electrode weakens. Therefore, even though the grounding electrode is not formed to be particularly larger than the radiating electrode, the radiation in the zenith direction can be increased.

In addition, it is preferable that the notched portions are formed at a plurality of positions substantially point-symmetric with respect to a center of the grounding electrode, so that the notched portion does not adversely affect the radiation from the radiating electrode. For example, if the dielectric substrate has a square shape in a plan view and the notched portions are formed at positions close to approximately middle portions of sides thereof respectively, the patch antenna can operate as a circularly polarized wave antenna having a high gain in the zenith direction.

In the patch antenna according to the present invention, the grounding electrode provided on the bottom surface of the dielectric substrate is formed to have concave notched portions and the path length of the induced current flowing to the outer circumferential edge of the grounding electrode is lengthened by the notched portions. Thus, the downward radiation due to the induced current of the grounding electrode can weaken and the radiation in the zenith direction can strengthen at the same rate opposite to the weakening rate. Therefore, in order to strengthen the radiation in the zenith direction, there is no need forming the grounding electrode large. As a result, a small patch antenna which needs a high gain in the zenith direction can be easily implemented.

### BRIEF DESCRIPTION OF THE DRAWINGS

FIG. 1 is a plan view of a patch antenna according to an embodiment of the present invention;

FIG. 2 is a bottom view of the patch antenna;

FIG. 3 is a perspective view of the patch antenna;

FIG. 4 is a cross-sectional view of the patch antenna;

FIG. 5 is a characteristic diagram showing a radiation pattern of the patch antenna; and

FIG. 6 is a characteristic diagram showing a radiation pattern of a comparative example.

### DESCRIPTION OF THE PREFERRED EMBODIMENT

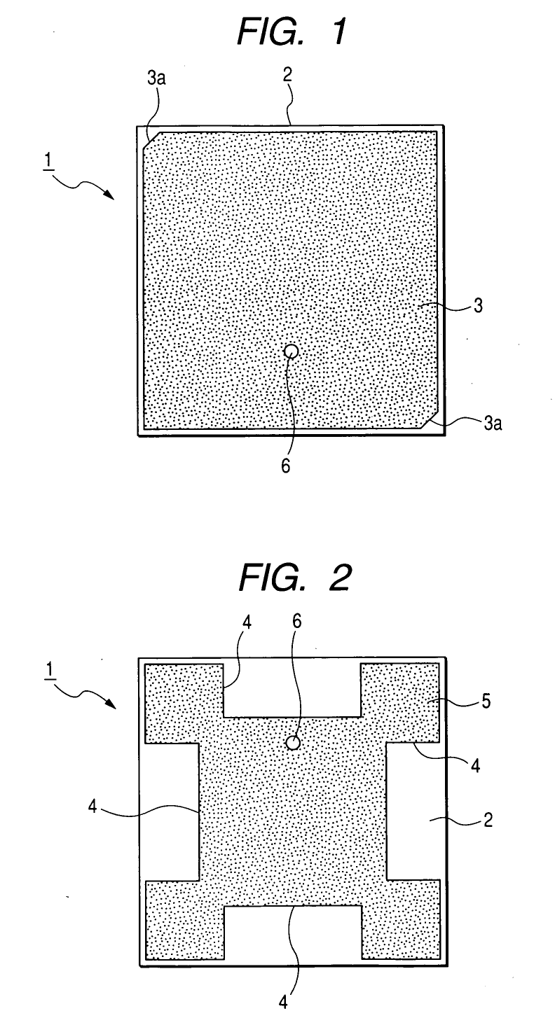

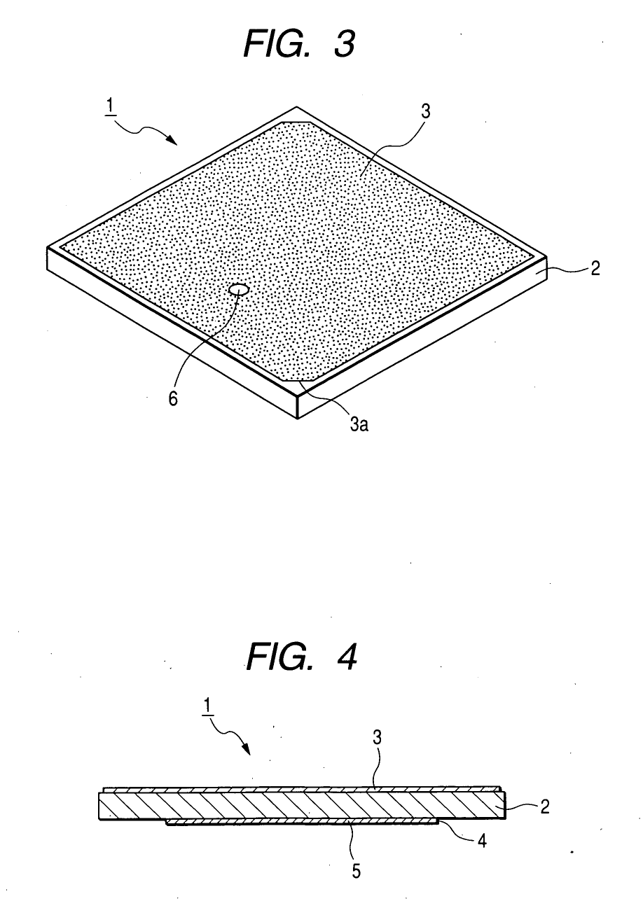

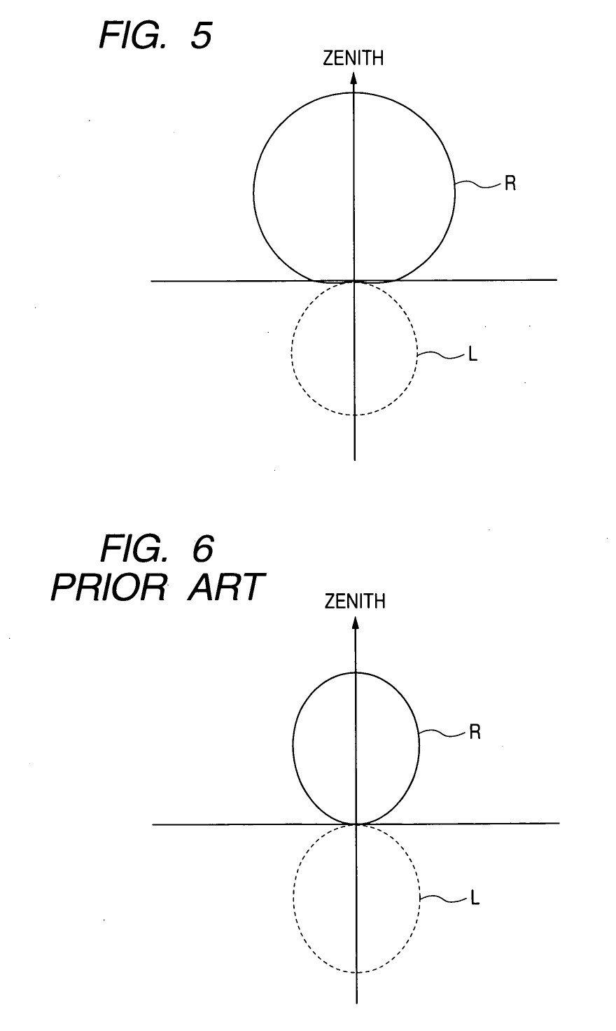

A preferred embodiment of the present invention will now be described with reference to the drawings. FIG. 1 is a plan view of a patch antenna according to an embodiment of the present invention, FIG. 2 is a bottom view of the patch antenna, FIG. 3 is a perspective view of the patch antenna, FIG. 4 is a cross-sectional view of the patch antenna, and FIG. 5 is a characteristic diagram showing a radiation pattern of the patch antenna.

A patch antenna 1 shown in FIGS. 1 to 4 is designed as a circularly polarized wave antenna for a GPS. The patch antenna 1 comprises a dielectric substrate 2 having a square shape in a plan view and being made of a dielectric material having a relative dielectric constant of about 4.0, a radiating electrode (a patch electrode) 3 having substantially a square shape and being provided on a top surface of the dielectric substrate 2, a grounding electrode (a rear electrode) 5 having notched portions 4 at four positions and being provided on a bottom surface of the dielectric substrate 2, and a feeding pin 6 passing though the dielectric substrate 2 and being soldered to a feeding point of the radiating electrode 3.

The radiating electrode 3 and the grounding electrode 5 are formed by etching a copper foil or the like into a predetermined shape, and two degeneracy breaking elements 3a are disposed at both ends of one diagonal of the radiating electrode 3 respectively. The radiating electrode 3 is formed almost entirely on the top surface of the dielectric substrate 2, except for areas corresponding to the two degeneracy breaking elements 3a. The notched portions 4 are formed at positions close to approximately middle portions of four sides of the dielectric substrate 2 respectively, and distances between the adjacent notched portions 4 are equal. The grounding electrode 5 is formed almost entirely on the bottom surface of the dielectric substrate 2, except for areas corresponding to the respective notched portions 4. The feeding pin 6 passing through the dielectric substrate 2 is connected to a LNA (Low Noise Amplifying Circuit) (not shown) while being maintained not to contact the grounding electrode 5.

The dimensions of the patch antenna 1 will be described. The top surface and the bottom surface of the dielectric substrate 2 both have equal length and width of 45 mm (square) and the dielectric substrate 2 has a plate thickness of 3 mm. In addition, the respective notched portions 4 are equally formed into a rectangle of which a length of a longer side is 20 mm and a length of a shorter side is 8 mm.

The patch antenna 1 constructed in such a manner is designed by disposing the degeneracy breaking elements 3a such that lengths of a pair of diagonals of the radiating electrode 3 are different by a predetermined amount and a 90 degree phase difference between a mode along one diagonal and a mode along the other diagonal occurs at the time of feeding. Thus, the patch antenna operates as a circularly polarized wave antenna. In addition, at the time of feeding, induced currents corresponding to the respective modes occur in the grounding electrode 5. However, in this case, the dimension of the main induced current crossing the center of the grounding electrode 5 among paths along the diagonals of the radiating electrode 3 is set such that gaps between the adjacent notched portions do not become extremely narrow. Thus, the flow of the induced current is not interfered by the notched portions 4, and excitation of the radiating electrode 3 is not likely to be damaged. In contrast, the induced current flowing to the outer circumferential edge of the grounding electrode 5 flows through a path along the notched portions 4, the length of the path drastically lengthens. As a result, as shown in FIG. 5, a gain of a left-handed polarized wave (radiation pattern L) radiated downward by the induced current of the grounding electrode 5 drastically decreases, and a gain of a right-handed polarized wave (radiation pattern R) radiated in the zenith direction from the radiating electrode 3 drastically increases by that amount.

FIG. 6 shows a radiation pattern in the case where a grounding electrode 5 having no notched portion 4 has a square shape, as a comparative example. In this case, since the grounding electrode 5 is the same shape as that of a radiating electrode 3, a gain of a left-handed polarized wave (radiation pattern L) radiated downward by the induced current of the grounding electrode 5 approximately equals to a gain of a right-handed polarized wave (radiation pattern R) radiated in the zenith direction from the radiating electrode 3. Therefore, a desired gain in the zenith direction can not be obtained.

As described above, in the patch antenna 1 according to the present embodiment, the downward radiation is suppressed by the notched portions 4 even though the grounding electrode 5 is not formed larger than the radiating electrode 3. Thus, the radiation pattern having a high gain in the zenith direction can be obtained. Therefore, even though the size of the dielectric substrate 2 decreases up to the size of the radiating electrode 3, the patch antenna 1 can reliably receive the circularly polarized waves from a GPS satellite.

In addition, in order to improve the gain in the zenith direction by providing the grounding electrode 5 with the notched portions 4, the plate thickness of the dielectric substrate 2 is preferably set to a value equal to or less than a predetermined dimension. More specifically, when a wavelength of a reception frequency in air is λ and a relative dielectric constant of the dielectric substrate 2 is ε, the plate thickness t of the dielectric substrate 2 is preferably set to a value equal to or less than 0.05λ/√ε.

In addition, in this embodiment, the circularly polarized wave antenna of the one-point feeding type of which the radiating electrode has substantially a square shape is described. According to the present invention, however, as for circularly polarized wave antennas of which a radiating electrode has another shape, circularly polarized wave antennas of a two-point feeding type, or linear polarized wave antennas, by providing theses antennas with concave notched portions, the same advantages as those in the present embodiment can be expected. In this case, the notched portions are preferably formed at a plurality of positions substantially point-symmetric with respect to the center of the grounding electrode, so that the notched portion does not adversely affect the radiation from the radiating electrode.

1. A patch antenna comprising:
a radiating electrode provided on a top surface of a dielectric substrate; and
a grounding electrode having concave notched portions and being provided on a bottom surface of the dielectric substrate.

2. The patch antenna according to claim 1,
wherein the notched portions are formed at a plurality of positions substantially point-symmetric with respect to a center of the grounding electrode.

3. The patch antenna according to claim 2,
wherein the dielectric substrate has a square shape in a plan view and the notched portions formed at positions close to centers of sides respectively and functions as a circularly polarized wave antenna.
